(19) United States
(12) Patent Application Publication
(10) Pub. No.: US 2003/0016302 A1
(43) Pub. Date: Jan. 23, 2003

(54) Apparatus and method for conditioning digital image data for display of the image represented thereby

(76) Inventors: Brian Fudge, San Diego, CA (US); John Ratzel, San Diego, CA (US); Mario Scipione, Rancho Santa Fe, CA (US)

Correspondence Address: QUALCOMM Incorporated, Attn: Patent Department, 5775 Morehouse Drive, San Diego, CA, 92121-1714, US

(21) Appl. No.: 09/901,783

(22) Filed: Jul. 9, 2001

(51) Int. Cl. H04N 7/01; H04N 11/20

(52) U.S. Cl. 348/441

(57) ABSTRACT

A system for conditioning digital image data for display of the image represented thereby is arranged such that data defining an image is supplied as pixel data and is formatted before being output for display. The pixel data defines a multiplicity of pixels which together form an image and is stored for processing. A set of parameters defining each of a plurality of different image displaying formats is also stored in a format data table. The digital image data is read from the store, formatted depending on the set of parameters for a selected image display format, and output for display of the image represented thereby in the selected image display format.

### BACKGROUND OF THE INVENTION

I. Field of the Invention

The present invention relates to a method and apparatus for conditioning digital image data for display of the image represented thereby. The invention also relates to a method and apparatus for converting image data between image data formats. The invention may be usefully employed in the newly emerging field of digital cinema.

II. Description of the Related Art

In the traditional film industry, theatre operators receive reels of celluloid film from a studio or through a distributor for eventual presentation in a theatre auditorium. The reels of film include the feature program (a full-length motion picture) and a plurality of previews and other promotional material, often referred to as trailers. This approach is well established and is based in technology going back nearly one hundred years.

Recently an evolution has started in the film industry, with the industry moving from celluloid film to digitized image and audio programs. Many advanced technologies are involved and together those technologies are becoming known as digital cinema. It is planned that digital cinema will provide a system for delivering full length motion pictures, trailers, advertisements and other audio/visual programs comprising images and sound at “cinema-quality” to theatres throughout the world using digital technology. Digital cinema will enable the motion picture cinema industry to convert gracefully from the century-old medium of 35 mm film into the digital/wireless communication era of today. This advanced technology will benefit all segments of the movie industry.

The intention is that digital cinema will deliver motion pictures that have been digitized, compressed and encrypted to theatres using either physical media distribution (such as DVD-ROMs) or electronic transmission methods, such as via satellite multicast methods. Authorized theatres will automatically receive the digitized programs and store them in hard disk storage while still encrypted and compressed. At each showing, the digitized information will be retrieved via a local area network from the hard disk storage, be decrypted, decompressed and then displayed using cinema-quality electronic projectors featuring high quality digital sound.

Digital cinema will encompass many advanced technologies, including digital compression, electronic security methods, network architectures and management, transmission technologies and cost-effective hardware, software and integrated circuit design. The technologies necessary for a cost-effective, reliable and secure system are being analyzed and developed. These technologies include new forms of image compression, because most standard compression technologies, such as MPEG-2, are optimized for television quality. Thus, artifacts and other distortions associated with that technology show up readily when the image is projected on a large screen. Whatever the image compression method adopted, it will affect the eventual quality of the projected image. Special compression systems which have been designed specifically for digital cinema applications provide “cinema-quality” images at bit rates averaging less than 40 Mbps. Using this technology a 2-hour movie will require only about 40 GB of storage, making it suitable for transportation on such media as so-called digital versatile disks (DVDs) or transmission or broadcast via a wireless link.

Image data may be delivered in a variety of different formats each with their own combination of frame sizes, active frame areas and color representation. In some formats the frames are divided into separate fields and in others they are not. Some formats represent the color of pixels in the so-called 4:4:4 chroma format, in which equal amounts of data are used too represent luminance (Y) and chrominance or color difference (Cr and Cb). Alternatively, the 4:2:2 format may be used in which twice as much information is used to represent the Y (luminance) component as is used to represent each of the two chroma (Cr and Cb) components. The following table 1 represents a selection of the many different formats that are available.

TABLE 1

| | Format | | | |
|---|---|---|---|---|
| | Video 1 | Movie 1/1A | Movie 2/2A | Movie 3 |
| Active | 1920 | 1920 | 2000 | 2560 |
| pixels/line | | | | |
| Active | 1080 | 1080 | 1080 | 1080 |
| lines/frame | | | | |
| Total | 2200 | 2750 | 2750 | 2750 |
| pixel/line | | | | |
| Total | 1125 | 1125 | 1125 | 1125 |
| lines/frame | | | | |
| Interlaced? | Yes | No | No | No |
| Frames/sec | 30 | 24 | 24 | 24 |
| Chroma | 4:2:2 | 4:4:4 or 4:2:2 | 4:4:4 or 4:2:2 | 4:4:4 or 4:2:2 |
| sampling | | | | |
| Pixel aspect | 1:1 | 1:1 | 1:1 | 1:1 |
| ratio | | | | |

Plainly, it would be advantageous in a digital cinema system to be able to receive/output data in a variety of different formats in order to enable the images to be supplied from different sources and displayed using different displaying equipment. That would allow a variety of digital video equipment to be interfaced with other parts of the digital cinema system.

### SUMMARY OF THE INVENTION

The invention aims to provide a method and apparatus for conditioning digital image data for display of the image represented thereby. The invention also aims to provide a method and apparatus for converting image data between image data formats.

According to one aspect of the invention, there is provided an apparatus for conditioning digital image data for display of the image represented thereby, the apparatus comprising: a store for storing digital image data defining a multiplicity of pixels which together form an image; a format data table defining a set of parameters for each of a plurality of different image displaying formats; and an image data processor for reading the digital image data from the store, for formatting the image data depending on the set of parameters for a selected image display format, and for outputting the formatted image data for display of the image represented thereby in the selected image display format.

According to another aspect of the invention there is provided a method of conditioning digital image data for display of the image represented thereby, the method comprising: storing digital image data defining a multiplicity of pixels which together form an image; defining a set of parameters for each of a plurality of different image displaying formats; formatting the image data depending on the set of parameters for a selected image display format; and outputting the formatted image data for display of the image represented thereby in the selected image display format.

According to a further aspect of the invention there is provided an image data processing system comprising: an input device for receiving image data defining a multiplicity of pixels that together form an image; a programmable format data store for storing format data defining a format in which the image data is to be output for display of the image; and a processor for receiving the image data from the input device and processing the same depending on the format data in the programmable format data store to generate image data including control data corresponding to the format defined by the format data in the format data store.

According to another aspect of the invention there is provided a method of image data processing comprising: receiving image data defining a multiplicity of pixels that together form an image; generating format data defining a format in which the image data is to be output for display of the image; and processing the image data from the input device depending on the format data in the programmable format data store to generate image data including control data corresponding to the format defined by the format data in the format data store.

The invention also provides a digital cinema system in which image data acquired in a first format is processed to remove control data therefrom and leave stripped data defining a multiplicity of pixels that together represent an image, the stripped data is delivered to a display sub-system together with data identifying the first format, at which display sub-system the stripped data is processed by a video processor which adds to the stripped data further data to convert the stripped data into reformatted data representing the image in a second format which is output to a display device for display of the image represented thereby.

The invention further provides a video display system in which data defining an image is supplied as pixel data and is formatted before being output for display, the system comprising: means for storing the pixel data; means for reading the pixel data, from the means for storing, in display order; means for selecting a display format in which the image is to be displayed; processing means, coupled to the means for reading and to the means for defining, for processing the pixel data to create display data by adding control data corresponding to the format selected for display.

The invention also provides a video display method in which data defining an image is supplied as pixel data and is formatted before being output for display, the system comprising: storing the pixel data; reading the stored pixel data in display order; selecting a display format in which the image is to be displayed; processing the pixel data to create display data by adding control data corresponding to the format selected for display.

The invention, among other things, facilitates the inputting and outputting of data in a variety of different formats, each with their own frame rates, clock speeds image sizes and pixel bandwidths. This facility for flexible playback enables both static and moving images to be supplied from a wide variety of different sources and displayed using different displaying equipment.

### BRIEF DESCRIPTION OF THE DRAWINGS

The above and further features of the invention are set forth with particularity in the appended claims and together with advantages thereof will become clearer from consideration of the following detailed description of an exemplary embodiment of the invention given with reference to the accompanying drawings, in which:

FIG. 1 illustrates a block diagram of a digital cinema system;

FIG. 2 is a block diagram of a compressor/encryptor circuit used in the system of FIG. 1;

FIG. 3 illustrates an auditorium module used in the system of FIG. 1;

FIG. 4 is a block diagram of a decryptor/decompressor module;

FIG. 5 is a block diagram of a pixel interface processor;

FIG. 6 shows image areas in a frame of progressive scan format;

FIG. 7 shows image areas in fields of an interlaced scan format;

FIG. 8 is a state diagram of a state machine used in the pixel interface processor of FIG. 5; and

FIG. 9 is a block diagram representing a theater manager and its associated interfaces used in the system of FIG. 1.

### DETAILED DESCRIPTION OF AN EMBODIMENT OF THE INVENTION

The following description is intended to provide both an overview of a digital cinema system in which the invention may be embodied and a detailed disclosure of the presently preferred embodiment itself. Systems similar to the system shown herein are described extensively in other applications assigned to the assignee of this application, including U.S. Ser. No. 09/564,174 entitled “Apparatus And Method For Encoding And Storage Of Digital Image And Audio Signals” and U.S. Ser. No. 09/563,880, entitled “Apparatus And Method For Decoding Digital Image And Audio Signals” both filed May 3, 2000, the teachings of which are incorporated herein by reference.

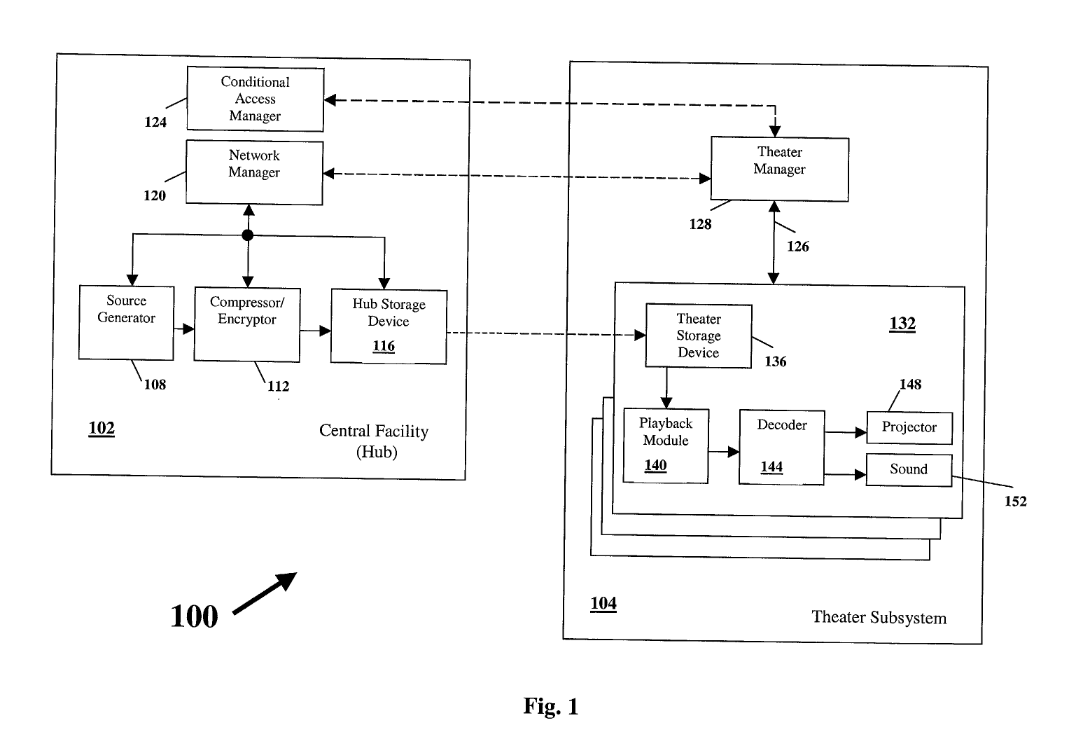

A digital cinema system 100 embodying the invention is illustrated in FIG. 1 of the accompanying drawings. The digital cinema system 100 comprises two main systems: at least one central facility or hub 102 and at least one presentation or theater subsystem 104. The hub 102 and the theater subsystem 104 are of a similar design to that of pending U.S. patent application Ser. No. 09/075,152 filed on May 8, 1998, assigned to the same assignee as the present invention, the teachings of which are incorporated herein by reference.

Image and audio information are compressed and stored on a storage medium, and distributed from the hub 102 to the theater subsystem 104. Generally, one theater subsystem 104 is utilized for each theater or presentation location in a network of presentation locations that is to receive image or audio information, and includes some centralized equipment as well as certain equipment employed for each presentation auditorium.

In the central hub 102, a source generator 108 receives film material and generates a digital version of the film. The digital information is compressed and encrypted by a compressor/encryptor (CE) 112, and stored on a storage medium by a hub storage device 116. A network manager 120 monitors and sends control information to the source generator 108, the CE 112, and the hub storage device 116. A conditional access manager 124 provides specific electronic keying information such that only specific theaters are authorized to show specific programs.

In the theater subsystem 104, a theater manager 128 controls an auditorium module 132. Based on control information received from the auditorium module 132, a theater storage device 136 transfers compressed information stored on the storage medium to a playback module 140. The playback module 140 receives the compressed information from the theater storage device 136, and prepares the compressed information to a predetermined sequence, size and data rate. The playback module 140 outputs the compressed information to a decoder 144. The decoder 144 inputs compressed information from the playback module 140 and performs decryption, decompression and formatting, and outputs the information to a projector 148 and a sound module 152. The projector 148 plays the information on a projector and the sound module 152 plays sound information on a sound system, both under control of the auditorium module 132.

In operation, the source generator 108 provides digitized electronic image and/or programs to the system. Typically, the source generator 108 receives film material and generates a magnetic tape containing digitized information or data. The film is digitally scanned at a very high resolution to create the digitized version of the motion picture or other program. Typically, a known “telecine” process generates the image information while well-known digital audio conversion processing generates the audio portion of the program. The images being processed need not be provided from a film, but can be single picture or still frame type images, or a series of frames or pictures, including those shown as motion pictures of varying length. These images can be presented as a series or set to create what are referred to as image programs. In addition, other material can be provided such as visual cue tracks for sight-impaired audiences, subtitling for foreign language and/or hearing impaired audiences, or multimedia time cue tracks. Similarly, single or sets of sounds or recordings are used to form desired audio programs.

Alternatively, a high definition digital camera or other known digital image generation device or method may provide the digitized image information. The use of a digital camera, which directly produces the digitized image information, is especially useful for live event capture for substantially immediate or contemporaneous distribution. Computer workstations or similar equipment can also be used to directly generate graphical images that are to be distributed.

The digital image information or program is presented to the compressor/encryptor 112, which compresses the digital signal using a preselected known format or process, reducing the amount of digital information necessary to reproduce the original image with very high quality. Preferably, an ABSDCT technique is used to compress the image source. A suitable ABSDCT compression technique is disclosed in U.S. Pat. Nos. 5,021,891, 5,107,345, and 5,452,104, the teachings of which are incorporated herein by reference. The audio information may also be digitally compressed using standard techniques and may be time synchronized with the compressed image information. The compressed image and audio information is then encrypted and/or scrambled using one or more secure electronic methods.

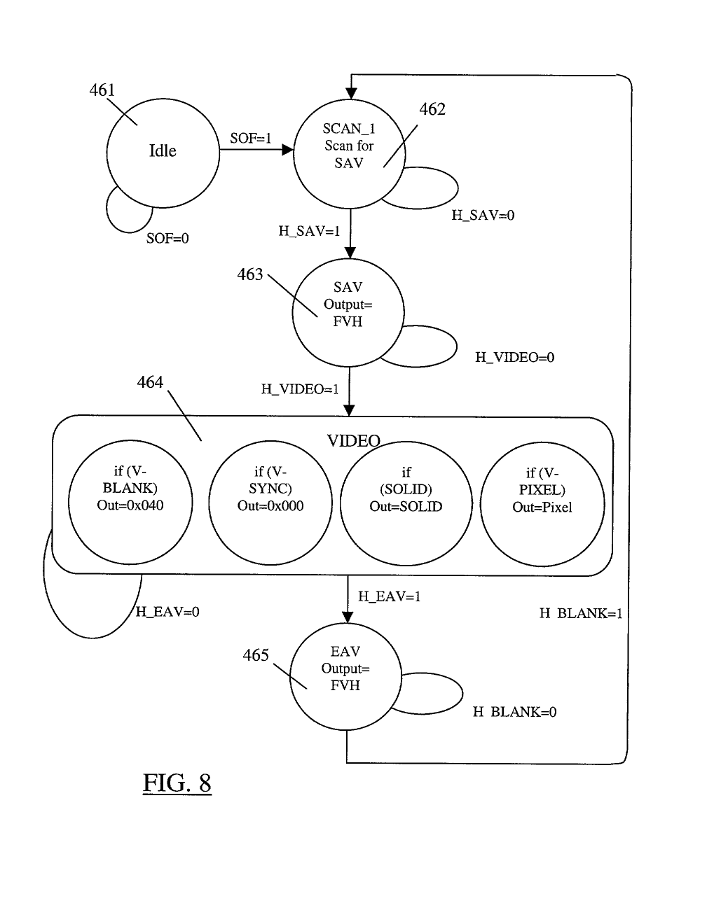

The network manager 120 monitors the status of compressor/encryptor 112, and directs the compressed information from the compressor/encryptor 112 to the hub storage device 116. The hub storage device 116 is comprised of one or more storage media (shown in FIG. 8). The storage medium/media may be any type of high capacity data storage device including, but not limited to, one or more digital versatile disks (DVDs) or removable hard drives (RHDs). Upon storage of the compressed information onto the storage medium, the storage medium is physically transported to the theater subsystem 104, and more specifically, to the theater storage device 136.

Alternatively, the compressed image and audio information may each be stored in a non-contiguous or separate manner independent of each other. That is, a means is provided for compressing and storing audio programs associated with image information or programs but segregated in time. There is no requirement to process the audio images at the same time. A predefined identifier or identification mechanism or scheme is used to associate corresponding audio and image programs with each other, as appropriate. This allows linking of one or more preselected audio programs with at least one preselected image program, as desired, at a time of presentation, or during a presentation event. That is, while not initially time synchronized with the compressed image information, the compressed audio is linked and synchronized at presentation of the program.

Further, maintaining the audio program separate from the image program allows for synchronizing multiple languages from audio programs to the image program, without having to recreate the image program for each language. Moreover, maintaining a separate audio program allows for support of multiple speaker configurations without requiring interleaving of multiple audio tracks with the image program.

In addition to the image program and the audio program, a separate promotional program, or promo program, may be added to the system. Typically, promotional material changes at a greater frequency than the feature program. Use of a separate promo program allows promotional material to be updated without requiring new feature image programs. The promo program comprises information such as advertising (slides, audio, motion or the like) and trailers shown in the theater. Because of the high storage capacity of storage media such as DVDs and RHDs, thousands of slides or pieces of advertising may be stored. The high storage volume allows for customization, as specific slides, advertisements or trailers may be shown at specific theaters to targeted customers.

Although FIG. 1 illustrates the compressed information in the storage device 116 and physically transporting storage medium/media to the theater subsystem 104, it should be understood that the compressed information, or portions thereof, may be transmitted to the theater storage device 136 using any of a number wireless or wired transmission methods. Transmission methods include satellite transmission, well-known multi-drop, Internet access nodes, dedicated telephone lines, or point-to-point fiber optic networks.

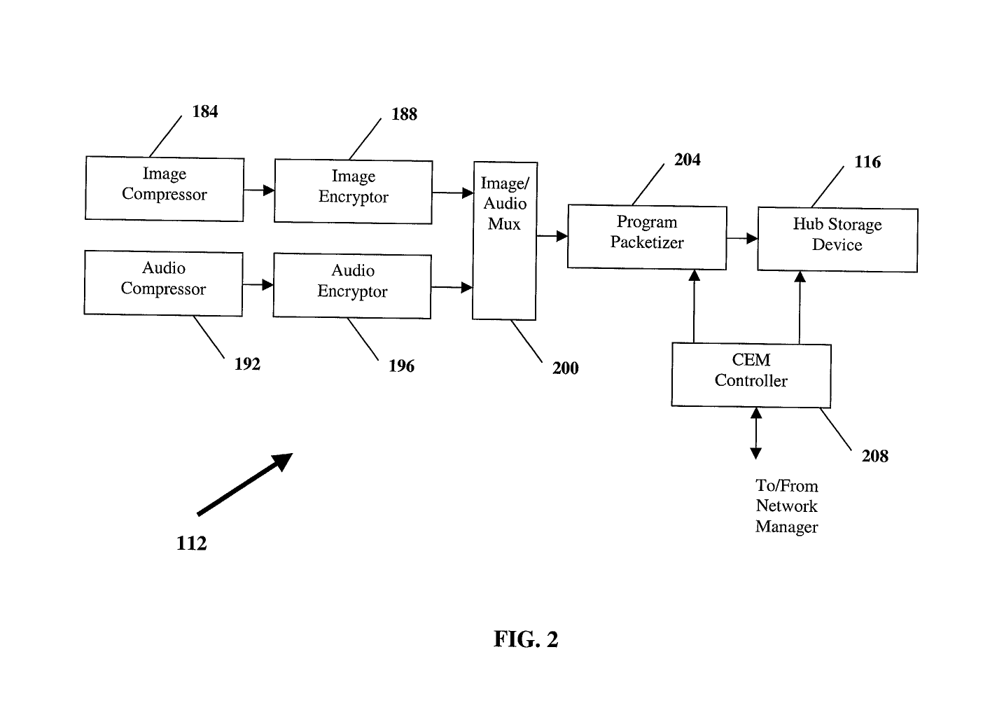

A block diagram of the compressor/encryptor 112 is illustrated in FIG. 2 of the accompanying drawings. Similar to the source generator 108, the compressor/encryptor 112 may be part of the central hub 102 or located in a separate facility. For example, the compressor/encryptor 112 may be located with the source generator 108 in a film or television production studio. In addition, the compression process for either image or audio information or data may be implemented as a variable rate process.

The compressor/encryptor 112 receives a digital image and audio information signal provided by the source generator 108. The digital image and audio information may be stored in frame buffers (not shown) before further processing. The digital image signal is passed to an image compressor 184. In a preferred embodiment, the image compressor 184 processes a digital image signal using the ABSDCT technique described in the abovementioned U.S. Pat. Nos. 5,021,891, 5,107,345, and 5,452,104.

In the ABSDCT technique, the color input signal is generally in a YIQ format, with Y being the luminance, or brightness, component, and I and Q being the chrominance, or color, components. Other formats such as the YUV, YC_{b}Cᵣ, or RGB formats may also be used. Because of the low spatial sensitivity of the eye to color, the ABSDCT technique sub-samples the color (I and Q) components by a factor of two in each of the horizontal and vertical directions. Accordingly, four luminance components and two chrominance components are used to represent each spatial segment of image input. The ABS DCT technique supports the so-called 4:4:4 format in which full sampling of the chrominance component takes place. Pixels in each component are represented by up to 10 bits in a linear or log scale.

Each of the luminance and chrominance components is passed to a block interleaver. Generally, a 16×16 block is presented to the block interleaver, which orders the image samples within the 16×16 blocks to produce blocks and composite sub-blocks of data for discrete cosine transform (DCT) analysis. The DCT operator is one method of converting a time-sampled signal to a frequency representation of the same signal. By converting to a frequency representation, the DCT techniques have been shown to allow for very high levels of compression, as quantizers can be designed to take advantage of the frequency distribution characteristics of an image. Preferably, one 16×16 DCT is applied to a first ordering, four 8×8 DCTs are applied to a second ordering, 16 4×4 DCTs are applied to a third ordering, and 64 2×2 DCTs are applied to a fourth ordering.

The DCT operation reduces the spatial redundancy inherent in the image source. After the DCT is performed, most of the image signal energy tends to be concentrated in a few DCT coefficients.

For the 16×16 block and each sub-block, the transformed coefficients are analyzed to determine the number of bits required to encode the block or sub-block. Then, the block or the combination of sub-blocks, which requires the least number of bits to encode, is chosen to represent the image segment. For example, two 8×8 sub-blocks, six 4×4 sub-blocks, and eight 2×2 sub-blocks may be chosen to represent the image segment.

The chosen block or combination of sub-blocks is then properly arranged in order. The DCT coefficient values may then undergo further processing such as, but not limited to, frequency weighting, quantization, and coding (such as variable length coding) using known techniques, in preparation for transmission. The compressed image signal is then provided to at least one image encryptor 188.

The digital audio signal is generally passed to an audio compressor 192. Preferably, the audio compressor 192 processes multi-channel audio information using a standard digital audio compression algorithm. The compressed audio signal is provided to at least one audio encryptor 196. Alternatively, the audio information may be transferred and utilized in an uncompressed, but still digital, format.

The image encryptor 188 and the audio encryptor 196 encrypts the compressed image and audio signals, respectively, using any of a number of known encryption techniques. The image and audio signals may be encrypted using the same or different techniques. In a preferred embodiment, an encryption technique, which comprises real-time digital sequence scrambling of both image and audio programming, is used.

At the image and audio encryptors 188 and 196, the programming material is processed by a scrambler/encryptor circuit that uses time-varying electronic keying information (typically changed several times per second). The scrambled program information can then be stored or transmitted, such as over the air in a wireless link, without being decipherable to anyone who does not possess the associated electronic keying information used to scramble the program material or digital data.

Encryption generally involves digital sequence scrambling or direct encryption of the compressed signal. The words “encryption” and “scrambling” are used interchangeably and are understood to mean any means of processing digital data streams of various sources using any of a number of cryptographic techniques to scramble, cover, or directly encrypt said digital streams using sequences generated using secret digital values (“keys”) in such a way that it is very difficult to recover the original data sequence without knowledge of the secret key values.

Each image or audio program may use specific electronic keying information which is provided, encrypted by presentation-location or theater-specific electronic keying information, to theaters or presentation locations authorized to show that specific program. The conditional access manager (CAM) 124 handles this function. The encrypted program key needed by the auditorium to decrypt the stored information is transmitted, or otherwise delivered, to the authorized theaters prior to playback of the program. Note that the stored program information may potentially be transmitted days or weeks before the authorized showing period begins, and that the encrypted image or audio program key may be transmitted or delivered just before the authorized playback period begins. The encrypted program key may also be transferred using a low data rate link, or a transportable storage element such as a magnetic or optical media disk, a smart card, or other devices having erasable memory elements. The encrypted program key may also be provided in such a way as to control the period of time for which a specific theater complex or auditorium is authorized to show the program.

Each theater subsystem 104 that receives an encrypted program key decrypts this value using its auditorium specific key, and stores this decrypted program key in a memory device or other secured memory. When the program is to be played back, the theater or location specific and program specific keying information is used, preferably with a symmetric algorithm, that was used in the encryptor 112 in preparing the encrypted signal to now descramble/decrypt program information in real-time.

Returning now to FIG. 2, in addition to scrambling, the image encryptor 188 may add a “watermark” or “fingerprint” which is usually digital in nature, to the image programming. This involves the insertion of a location specific and/or time specific visual identifier into the program sequence. That is, the watermark is constructed to indicate the authorized location and time for presentation, for more efficiently tracking the source of illicit copying when necessary. The watermark may be programmed to appear at frequent, but pseudo-random periods in the playback process and would not be visible to the viewing audience. The watermark is perceptually unnoticeable during presentation of decompressed image or audio information at what is predefined as a normal rate of transfer. However, the watermark is detectable when the image or audio information is presented at a rate substantially different from that normal rate, such as at a slower “non-real-time” or still frame playback rate. If an unauthorized copy of a program is recovered, the digital watermark information can be read by authorities, and the theater from which the copy was made can be determined. Such a watermark technique may also be applied or used to identify the audio programs.

The compressed and encrypted image and audio signals are both presented to a multiplexer 200. At the multiplexer 200, the image and audio information is multiplexed together along with time synchronization information to allow the image and audio-streamed information to be played back in a time aligned manner at the theater subsystem 104. The multiplexed signal is then processed by a program packetizer 204, which packetizes the data to form the program stream. By packetizing the data, or forming “data blocks,” the program stream may be monitored during decompression at the theater subsystem 104 (see FIG. 1) for errors in receiving the blocks during decompression. Requests may be made by the theater manager 128 of the theater subsystem 104 to acquire data blocks exhibiting errors. Accordingly, if errors exist, only small portions of the program need to be replaced, instead of an entire program. Requests of small blocks of data may be handled over a wired or wireless link. This provides for increased reliability and efficiency.

Alternatively, the image and audio portions of a program are treated as separate and distinct programs. Thus, instead of using the multiplexer 200 to multiplex the image and audio signals, the image signals are separately packetized. In this way the image program may be transported exclusive of the audio program, and vice versa. As such, the image and audio programs are assembled into combined programs only at playback time. This allows for different audio programs to be combined with image programs for various reasons, such as varying languages, providing post-release updates or program changes, to fit within local community standards, and so forth. This ability to flexibly assign audio different multi-track programs to image programs is very useful for minimizing costs in altering programs already in distribution, and in addressing the larger multi-cultural markets now available to the film industry.

The compressors 184 and 192, the encryptors 188 and 196, the multiplexer 200, and the program packetizer 204 may be implemented by a compression/encryption module (CEM) controller 208, a software-controlled processor programmed to perform the functions described herein. That is, they can be configured as generalized function hardware including a variety of programmable electronic devices or computers that operate under software or firmware program control. They may alternatively be implemented using some other technology, such as through an ASIC or through one or more circuit card assemblies, i.e. constructed as specialized hardware.

The image and audio program stream is sent to the hub storage device 116. The CEM controller 208 is primarily responsible for controlling and monitoring the entire compressor/encryptor 112. The CEM controller 208 may be implemented by programming a general-purpose hardware device or computer to perform the required functions, or by using specialized hardware. Network control is provided to CEM controller 208 from the network manager 120 (FIG. 2) over a hub internal network, as described herein. The CEM controller 208 communicates with the compressors 184 and 192, the encryptors 188 and 196, the multiplexer 200, and the packetizer 204 using a known digital interface and controls the operation of these elements. The CEM controller 208 may also control and monitor the storage module 116, and the data transfer between these devices.

The storage device 116 is preferably constructed as one or more RHDs, DVDs disks or other high capacity storage medium/media, which in general is of similar design as the theater storage device 116 in theater subsystem 104. However, those skilled in the art will recognize that in some applications other media may be used including but not limited to DVDs (Digital Versatile Disks) or so-called JBODs (“Just a Bunch Of Drives”). The storage device 116 receives the compressed and encrypted image, audio, and control data from the program packetizer 204 during the compression phase. Operation of the storage device 116 is managed by the CEM controller 208.

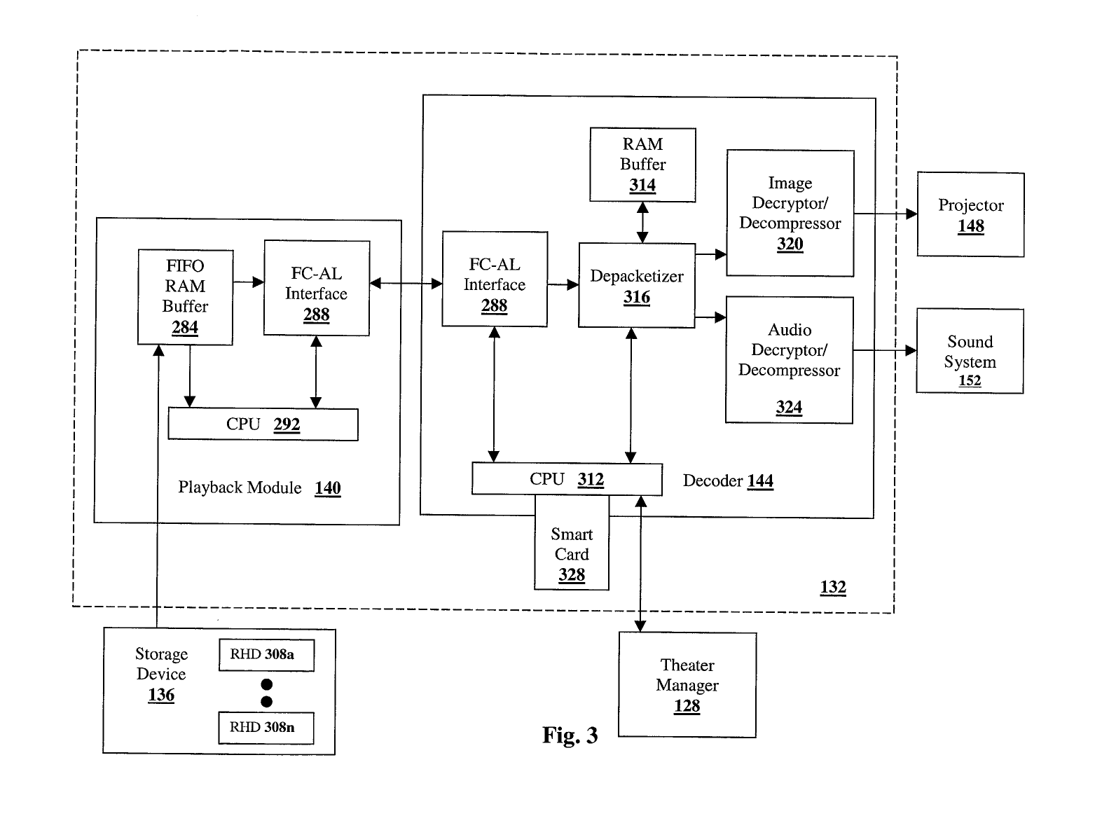

FIG. 3 of the accompanying drawings illustrates operation of the auditorium module 132 using one or more RHDs (removable hard drives) 308. For speed, capacity, and convenience reasons, it may be desirable to use more than one RHD 308a to 308n. When reading data sequentially, some RHDs have a “prefetching” feature that anticipates a following read command based upon a recent history of commands. This prefetching feature is useful in that the time required to read sequential information off the disk is reduced. However, the time needed to read non-sequential information off the disk may be increased if the RHD receives a command that is unexpected. In such a case, the prefetching feature of the RHD may cause the random access memory of the RHD to be full, thus requiring more time to access the information requested. Accordingly, having more than one RHD is beneficial in that a sequential stream of data, such as an image program, may be read faster. Further, accessing a second set of information on a separate RHD disk, such as audio programs, trailers, control information, or advertising, is advantageous in that accessing such information on a single RHD is more time consuming.

Thus, compressed information is read from one or more RHDs 308 into a buffer 284. The FIFO-RAM buffer 284 in the playback module 140 receives the portions of compressed information from the storage device 136 at a predetermined rate. The FIFO-RAM buffer 284 is of a sufficient capacity such that the decoder 144, and subsequently the projector 148, is not overloaded or under-loaded with information. Preferably, the FIFO-RAM buffer 284 has a capacity of about 100 to 200 MB. Use of the FIFO-RAM buffer 284 is a practical necessity because there may be a several second delay when switching from one drive to another.

The portions of compressed information is output from the FIFO-RAM buffer into a network interface 288, which provides the compressed information to the decoder 144. Preferably, the network interface 288 is a fiber channel arbitrated loop (FC-AL) interface. Alternatively, although not specifically illustrated, a switch network controlled by the theater manager 128 receives the output data from the playback module 140 and directs the data to a given decoder 144. Use of the switch network allows programs on any given playback module 140 to be transferred to any given decoder 144.

When a program is to be viewed, the program information is retrieved from the storage device 136 and transferred to the auditorium module 132 via the theater manager 128. The decoder 144 decrypts the data received from the storage device 136 using secret key information provided only to authorized theaters, and decompresses the stored information using the decompression algorithm which is inverse to the compression algorithm used at source generator 108. The decoder 144 includes a converter (not shown in FIG. 3) which converts the decompressed image information to an image display format used by the projection system (which may be either an analog or digital format) and the image is displayed through an electronic projector 148. The audio information is also decompressed and provided to the auditorium's sound system 152 for playback with the image program.

The decoder 144 will now be described in greater detail by further reference to FIG. 3. The decoder 144 processes a compressed/encrypted program to be visually projected onto a screen or surface and audibly presented using the sound system 152. The decoder 144 comprises a controlling CPU (central processing unit) 312, which controls the decoder. Alternatively, the decoder may be controlled via the theater manager 128. The decoder further comprises at least one depacketizer 316, a buffer 314, an image decryptor/decompressor 320, and an audio decryptor/decompressor 324. The buffer may temporarily store information for the depacketizer 316. All of the above-identified units of the decoder 144 may be implemented on one or more circuit card assemblies. The circuit card assemblies may be installed in a self-contained enclosure that mounts on or adjacent to the projector 148. Additionally, a cryptographic smart card 328 may be used which interfaces with controlling CPU 312 and/or image decryptor/decompressor 320 for transfer and storage of unit-specific cryptographic keying information.

The depacketizer 316 identifies and separates the individual control, image, and audio packets that arrive from the playback module 140, the CPU 312 and/or the theater manager 128. Control packets may be sent to the theater manager 128 while the image and audio packets are sent to the image and audio decryption/decompression systems 320 and 324, respectively. Read and write operations tend to occur in bursts. Therefore, the buffer 314 is used to stream data smoothly from the depacketizer 316 to the projection equipment.

The theater manager 128 configures, manages the security of, operates, and monitors the theater subsystem 104. This includes the external interfaces, image and audio decryption/decompression modules 320 and 324, along with projector 148 and the sound system module 152. Control information comes from the playback module 140, the CPU 312, the theater manager system 128, a remote control port, or a local control input, such as a control panel on the outside of the auditorium module 132 housing or chassis. The decoder CPU 312 may also manage the electronic keys assigned to each auditorium module 132. Pre-selected electronic cryptographic keys assigned to auditorium module 132 are used in conjunction with the electronic cryptographic key information that is embedded in the image and audio data to decrypt the image and audio information before the decompression process. Preferably, the CPU 312 uses a standard microprocessor running embedded in the software of each auditorium module 132, as a basic functional or control element.

In addition, the CPU 312 is preferably configured to work or communicate certain information with theater manager 128 to maintain a history of presentations occurring in each auditorium. Information regarding this presentation history is then available for transfer to the hub 102 using the return link, or through a transportable medium at preselected times.

The image decryptor/decompressor 320 takes the image data stream from depacketizer 316, performs decryption, adds a watermark and reassembles the original image for presentation on the screen. The output of this operation generally provides standard analog RGB signals to digital cinema projector 148. Typically, decryption and decompression are performed in real-time, allowing for real-time playback of the programming material.

The image decryptor/decompressor 320 decrypts and decompresses the image data stream to reverse the operation performed by the image compressor 184 and the image encryptor 188 of the hub 102. Each auditorium module 132 may process and display a different program from other auditorium modules 132 in the same theater subsystem 104 or one or more auditorium modules 132 may process and display the same program simultaneously. Optionally, the same program may be displayed on multiple projectors, the multiple projectors being delayed in time relative to each other.

The decryption process uses previously provided unit-specific and program-specific electronic cryptographic key information in conjunction with the electronic keys embedded in the data stream to decrypt the image information. Each theater subsystem 104 is provided with the necessary cryptographic key information for all programs authorized to be shown on each auditorium module 132.

A multi-level cryptographic key manager is used to authorize specific presentation systems for display of specific programs. This multi-level key manager typically utilizes electronic key values which are specific to each authorized theater manager 128, the specific image and/or audio program, and/or a time varying cryptographic key sequence within the image and/or audio program. An “auditorium specific” electronic key, typically 56 bits or longer, is programmed into each auditorium module 132.

This programming may be implemented using several techniques to transfer and present the key information for use. For example, the return link discussed above may be used through a link to transfer the cryptographic information from the conditional access manager 124. Alternatively, smart card technology such as smart card 328, pre-programmed flash memory cards, and other known portable storage devices may be used. For example, the smart card 328 may be designed so that this value, once loaded into the card, cannot be read from the smart card memory.

Physical and electronic security measures are used to prevent tampering with this key information and to detect attempted tampering or compromise. The key is stored in such a way that it can be erased in the event of detected tampering attempts. The smart card circuitry includes a microprocessor core including a software implementation of an encryption algorithm, typically Data Encryption Standard (DES). The smart card can input values provided to it, encrypt (or decrypt) these values using the on-card DES algorithm and the pre-stored auditorium specific key, and output the result. Alternatively, the smart card 328 may be used simply to transfer encrypted electronic keying information to circuitry in the theater subsystem 104 which would perform the processing of this key information for use by the image and audio decryption processes.

Image program data streams undergo dynamic image decompression using an inverse ABSDCT algorithm or other image decompression process symmetric to the image compression used in the central hub compressor/encryptor 112. If image compression is based on the ABSDCT algorithm the decompression process includes variable length decoding, inverse frequency weighting, inverse quantization, inverse differential quad-tree transformation, IDCT, and DCT block combiner deinterleaving. The processing elements used for decompression may be implemented in dedicated specialized hardware configured for this function such as an ASIC or one or more circuit card assemblies. Alternatively, the decompression processing elements may be implemented as standard elements or generalized hardware including a variety of digital signal processors or programmable electronic devices or computers that operate under the control of special function software or firmware programming. Multiple ASICs may be implemented to process the image information in parallel to support high image data rates.

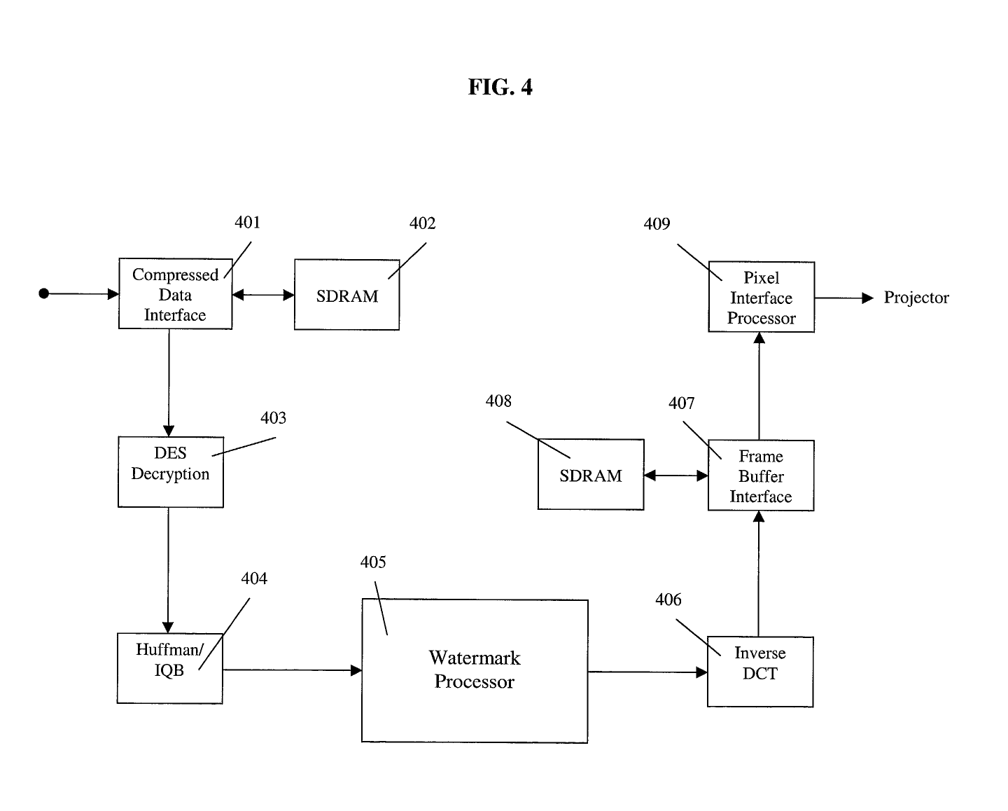

FIG. 4 of the accompanying drawings shows the decryptor/decompressor 320 in greater detail. The decryptor/decompressor 320 comprises a compressed data interface (CDI) 401, which receives the depacketised, compressed and encrypted data from the depacketiser 316 (see FIG. 3). Data tends to be moved around and processed in bursts, and so the received data is stored in a random access store 402, which is preferably an SDRAM device or similar, until it is needed. The data input to the SDRAM store 402 corresponds to compressed and encrypted versions of the image data. The store 402, therefore, need not be very large (relatively speaking) to be able to store data corresponding to a large number of image frames.

From time to time, the data is taken from the store 402 by the CDI 401 and output to a decryption circuit 403 where it is decrypted using a DES (Data Encryption Standard) key. The DES key is specific to the encryption performed at the central facility 102 (see FIG. 1) and, therefore, enables the incoming data to be decrypted. The data may also be compressed before it is transmitted from the central facility, using lossless techniques including Huffman or run-length encoding and/or lossy techniques including block quantisation in which the value of the data in a block is divided by a power of 2 (i.e. 2 or 4 or 8, etc). The decryptor/decompressor 320 thus comprises a decompressor, e.g. a Huffman/IQB decompressor 404 that decompresses the decrypted data. The decompressed data from the Huffman/IQB decompressor 404 represents the image data in the DCT domain.

Since the system already comprises the necessary hardware and software to effect DCT compression techniques, specifically the above-mentioned ABSDCT compression technique, to compress data, the same is used to embed a watermark into the picture in the DCT domain. Other transformations could, of course, be used but since the hardware is already there in the system this offers the most cost-effective solution.

Data from the decompressor 404 is, therefore, input to a watermark processor 405 where data defining a watermark is applied to the image data. The data from the watermark processor 405 is then input to an inverse DCT transforming circuit 406 where the data is converted from the DCT domain into image data in the pixel domain.

The thus produced pixel data is input to a frame buffer interface 407 and associated SDRAM store 408. The frame buffer interface 407 and associated store 408 serves as a buffer in which the pixel data is held for reconstruction in a suitable format for display of the image by a pixel interface processor 409. The SDRAM store 408 may be of a similar size to that of the SDRAM store 402 associated with the compressed data interface 401. However, since the data input to the frame buffer interface 407 represents the image in the pixel domain, data for only a comparatively small number of image frames can be stored in the SDRAM store 408. This is not a problem because the purpose of the frame buffer interface 407 is simply to reorder the data from the inverse DCT circuit and present it for reformatting by the pixel interface processor 409 at the display rate.

The decompressed image data goes through digital to analog conversion, and the analog signals are output to projector the 148 for display of the image represented by the image data. The projector 148 presents the electronic representation of a program on a screen. The high quality projector is based on advanced technology, such as liquid crystal light valve (LCLV) methods for processing optical or image information. The projector 148 receives an image signal from image decryptor/decompressor 320, typically in standard Red-Green-Blue (RGB) video signal format. Alternatively, a digital interface may be used to convey the decompressed digital image data to the projector 148 obviating the need for the digital-to-analog process. Information transfer for control and monitoring of the projector 148 is typically provided over a digital serial interface from the controller 312.

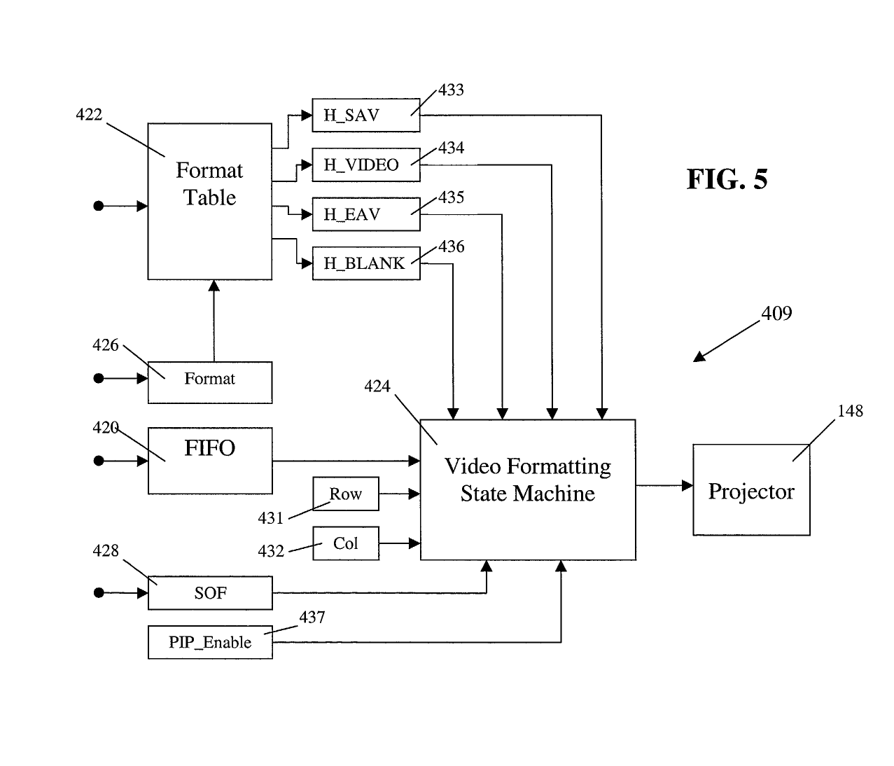

FIG. 5 of the accompanying drawings shows the pixel interface processor 409 in greater detail. The pixel interface processor 409 is arranged to receive image data derived from any one of several different image formats, including but not limited to the formats identified in the above discussed table. The interface processor 409 coverts the received data into a format compatible with that of the projector 148.

The pixel interface processor 409 is able to process both progressive and interlaced scanning formats. It is also able to process data representing a static image or set of static images, similar to a slideshow, say. With static images the interface processor 409 receives the data in a format corresponding to the motion picture format that most closely resembles that of the static image together with an instruction to display the one frame for multiple frame periods. A similar command can be sent to indicate that a given frame or frames in a moving image is/are bad and to cause the interface processor 409 to display a preceding or succeeding frame a number of times to compensate for the bad frame(s).

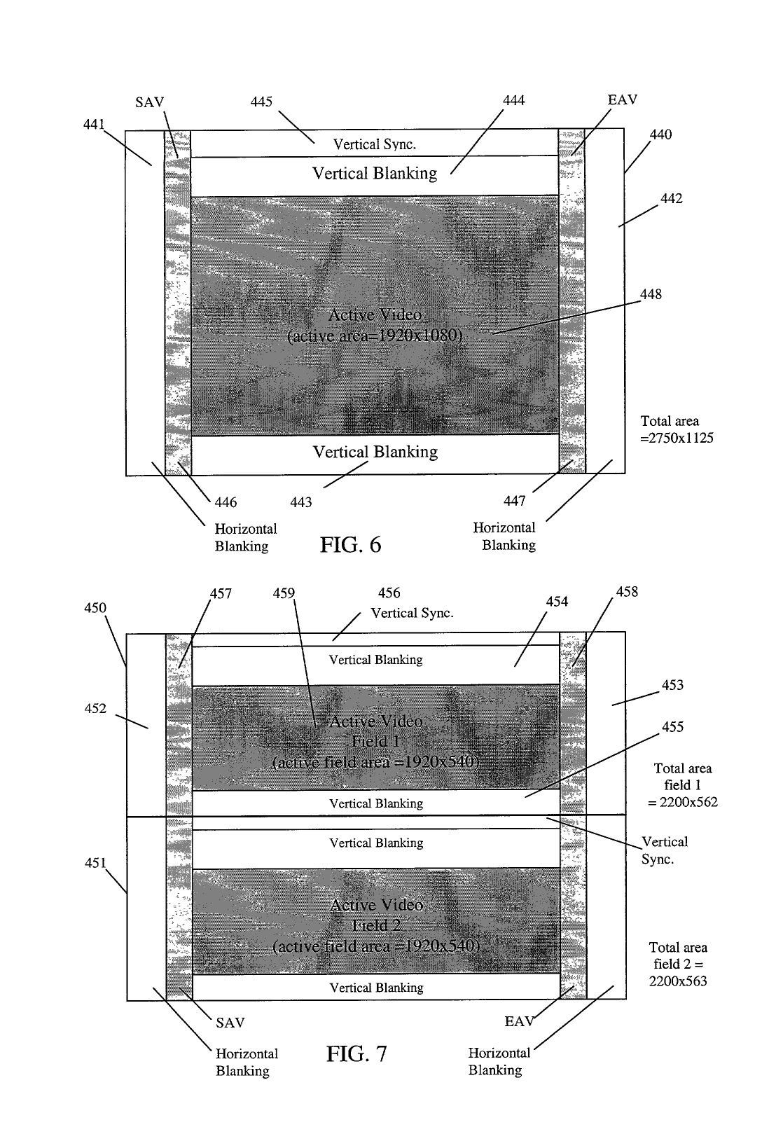

FIG. 6 of the accompanying drawings shows, by way of example, a frame 440 in the so-called Movie 1 format, which is a progressive scan format whose active and inactive sizes are identified in the above-provided Table 1. The Movie 1 frame 440 comprises regions of horizontal blanking 441,442, vertical blanking 443,444, vertical sync 445, special codes including start of active video (SAV) 446 and end of active video (EAV) 447 and a region of active pixels 448. The area of active pixels is 1920×1080 pixels but by the time all the control data has been added the total area of the frame is equivalent to 2750×1125 pixels. Other progressive scan formats have similar areas.

FIG. 7 of the accompanying drawings shows, by way of example, the fields 450,451 in the so-called Video 1 format, which is an interleaved scan format whose active and inactive sizes are also shown in the above-provided Table 1. Each field (e.g. field 450) comprises regions of horizontal blanking 452,453, vertical blanking 454,455, vertical sync 456, special codes including SAV 457 and EAV 458 and a region of active pixels 459. During display of the image, the two fields 450,451 are interleaved as is, of course, well known. The area of active pixels in each field is 1920×540 pixels but by the time all the control data has been added the total area of the first field is equivalent to 2200×562 pixels, the total area of the second field is equivalent to 2200×563 pixels and the total area of the two fields together is equivalent to 2750×1125 pixels.

Fuller information regarding the Movie 1 and Video 1 standards and others can be found in the SMPTE274 standard.

Regardless of whether the data initially represents the image in a progressive or an interlaced scan format, it is only the data representing the region of active pixels that is of interest to the interface processor 409. The data representing the regions of horizontal blanking, vertical blanking, vertical sync, SAV and EAV are therefore striped from the image data to leave the data representing the active pixels. This stripped data is processed by the interface processor 409 to add to it the necessary control signals to enable the image to be displayed by the projector.

In the following it will be assumed that the format of the projector is larger, in terms of the number of lines per frame and the number of pixels per line than any of the formats from which the image data could potentially be derived. As will be described in the following, the interface processor 409 is arranged to add blanking (e.g. black value) pixels at the beginning and/or end of each line of incoming data so that the lines of pixels output for display by the projector are of the correct size for the format of the projector.

Having said that, information defining the format in which the pixel data was generated is, of course, necessary for the pixel interface processor 409 to be able correctly to process the pixel data prior to display. This data is included in the data delivered to the theatre module 132, for example by way of the removable hard drives 308 shown in FIG. 3 of the accompanying drawings. This information is held in the frame buffer interface 407 (see FIG. 4) where it is used to transfer the pixel data for each field frame in the correct order, typically scanning from left to right and top to bottom, to the pixel interface processor 409. In order to facilitate the transfer of data, the frame buffer interface 407 is capable of addressing two or more independent frames.

In the following, the processing of data in the Y,Cr,Cb format will be described because that is the most common format likely to be encountered in the digital cinema field. The interface processor 409 could, if necessary or desirable, be applied equally to such formats as the RGB (Red, Green, Blue) format common in computing and the CMY (Cyan, Magenta, Yellow) format common in printing.

As shown in FIG. 5, the pixel interface processor 409 comprises a FIFO buffer 420 for receiving pixel data from the frame buffer interface 407 (see FIG. 4). The frame buffer interface 407 is responsible both for receiving and storing data from the inverse DCT module 406 (see FIG. 4) and for transferring data to the pixel interface processor 409. The frame buffer interface is therefore only available to the pixel interface processor 409 for half of the time. Due to the structure of a frame, in some periods the interface processor 409 will require a pixel every cycle; in others it may not require a pixel for a number of cycles. The pixel FIFO 420 is responsible for ensuring that the interface processor 409 always has enough active pixel data. The pixel FIFO 420 is sized accordingly to accommodate the maximum lag between each request cycle. Typically, the FIFO 420 will be at least 256 pixels large.

The pixel interface processor 409 also comprises a format table 422 which contains data defining the blanking active region parameters for the format in which the image is to be displayed, together with data from the frame buffer interface 407 identifying the size of the image in terms of numbers of pixels in each field/frame as stored in the SDRAM 408 of the frame buffer interface 407. The parameter data is generated by software and loaded into the format table 422 before the displaying of the image begins.

The pixel interface processor 409 also comprises a video formatting state machine 424, which controls operation of the pixel interface processor 409. The video formatting state machine 424 receives pixels from the frame buffer interface 407 via the FIFO 420 and formats them by adding appropriate control signals by deciding whether the current output region requires pixel data, blanking data or formatting codes. The state machine is driven by the data in the format table 422, thereby giving it the flexibility to support the required formats as well as formats with active pixel areas less than or equal to the required formats, as well as other larger formats at slower frame rates.

The video formatting state machine 424 starts running when it receives a start of frame signal 428. A pair of counters 431,432 keeps track of the current row and column in the frame. These counters 431,432 are passed through a series of comparators (not shown) within the video formatting state machine 424 to identify transitions between blanking control codes and active pixel data.

FIG. 8 shows the state diagram for the video formatting state machine. Five states, namely idle 461, scan 462, SAV (Start of Active Video) 463, video 464 and EAV (End of Active Video) 465 are defined for the state machine. The five defined states 461 to 465 correspond to horizontal regions shown in FIG. 6 of the accompanying drawings.

The control signals shown in FIG. 5, namely SOF (Start Of Frame) 428, H_SAV (Horizontal Start of Active Video) 433, H_VIDEO (Horizontal Video) 434, H_EAV (Horizontal End of Active Video) 435 and H_BLANK (Horizontal Blank) 436 control the progression of the state machine through the states. A further control signal, PIP_ENABLE 437, from the frame buffer interface enables and disables the state machine 424. All states have a path (not shown) to idle state 461 when PIP_ENABLE is low. For the sake of clarity, only a few control signals are shown in FIG. 5 as inputs to the state machine 424. However, each of the control signals referred to herein has an entry (or entries) in the format table 422. As the system is clocked (by the system clock—not shown), the current column is compared to the column specified in the table. If there is a match, the corresponding signal is held high for one system clock cycle.

A similar method is used to generate the V_SYNC, V_BLANK and V_PIXEL flags. When the state machine is in the video state 464, V_SYNC, V_BLANK and V_PIXEL flags (not shown) from the format table of FIG. 5 are used to indicate what type of active pixel should be output. These control signals are held high for the entire time the VIDEO state is enabled. An additional flag, solid (such as ALL_BLACK—not shown), is used to indicate that the frame should contain active pixels of a solid value instead of the values of the Pixel FIFO 420. This flag is used to when changing video format of the image output for display by adding black pixels to the data. If the data is in 4:2:2 chroma format, the video formatting state machine 424 time-multiplexes the Cb and Cr data on each pixel output cycle by selecting pixels from alternating sections of the pixel FIFO 420.

While it would be possible to incorporate in the pixel interface processor 409 a chroma converter for downsampling or decimating from 4:4:4 to 4:2:2 or interpolating from 4:2:2 to 4:4:4, it is presently preferred not to include such a converter. Such a scheme may be used is described in pending U.S. patent application Ser. No. 09/875,329, entitled “Selective Chrominance Decimation for Digital Images”, filed Jun. 5, 2001, assigned to the assignee of the present application and is specifically incorporated by reference herein. In an alternate embodiment, any such conversion that may be necessary is done when the image data is produced and/or at the central facility 102 (see FIG. 1). Therefore, the pixel data arriving at the FIFO 420 is already in the correct chroma format for display.

The FIFO 420 is partitioned into three sections, one for each color component. This is necessary for images in a decimated chroma format, i.e. 4:2:2, because in the 4:2:2 chroma mode, pixels for the Y component are processed every cycle and pixels for the Cb and Cr components are processed every other cycle. Decimated-chroma (4:2:2) image data is handled like any other data. The only difference is that the Cb and Cr information is only present in every other pixel transfer cycle from the frame buffer interface 407. The frame buffer interface is responsible for stuffing the decimated-chroma pixels into neighboring locations in memory. Since the frame buffer interface knows the frame structure and transfers the data in the correct order for display, the FIFO 420 is not required to reformat pixels as they arrive from the frame buffer interface 407.

Interlaced image data is handled in part by the frame buffer interface 407 and in part by a pixel format state machine 424 in the pixel interface processor 409. A control signal identifying interlaced image data tells the frame buffer interface 407 whether to read sequential lines of data or alternating even and odd lines of data. The pixel FIFO 420 does not operate differently depending on the control signal. However, format information is supplied to the pixel image processor 409 (as represented by register 426) that tells the pixel format state machine 424 whether pixel data should be output in frames (progressive scan) or fields (interlaced scan).

The table below illustrates different formatting schemes:

TABLE 2

| Original | Compressed | Display |
|---|---|---|
| Format | Format | Format |
| Progressive | Progressive | Progressive |
| Progressive | Progressive | Interlaced |
| Interlaced | Progressive | Interlaced |
| Interlaced | Progressive | Progressive |
| Interlaced | Interlaced | Progressive |
| Interlaced | Interlaced | Interlaced |

Regardless of the original format or the format in which the information is compressed or store, the displayed image may be progressive or interlaced.

The audio decryptor/decompressor 324 shown in FIG. 3 operates in a similar manner on the audio data, although it does not apply data representing a watermark or fingerprint to the audio signal. Of course such a watermark technique may also be applied or used to identify the audio programs, if desired. The audio decryptor/decompressor 324 takes the audio data stream from the depacketizer 316, performs decryption, and reassembles the original audio for presentation on a theater's speakers or audio sound system 152. The output of this operation provides standard line level audio signals to the sound system 152.

Similar to the image decryptor/decompressor 320, the audio decryptor/decompressor 324 reverses the operation performed by the audio compressor 192 and the audio encryptor 196 of the hub 102. Using electronic keys from the cryptographic smart card 328 in conjunction with the electronic keys embedded in the data stream, the decryptor 324 decrypts the audio information. The decrypted audio data is then decompressed.

Audio decompression is performed with an algorithm symmetric to that used at the central hub 102 for audio compression. Multiple audio channels, if present, are decompressed. The number of audio channels is dependent on the multi-phonic sound system design of the particular auditorium, or presentation system. Additional audio channels may be transmitted from the central hub 102 for enhanced audio programming for purposes such as multi-language audio tracks and audio cues for sight impaired audiences. The system may also provide additional data tracks synchronized to the image programs for purposes such as multimedia special effects tracks, subtitling, and special visual cue tracks for hearing impaired audiences.

As discussed earlier, audio and data tracks may be time synchronized to the image programs or may be presented asynchronously without direct time synchronization. Image programs may consist of single frames (i.e., still images), a sequence of single frame still images, or motion image sequences of short or long duration.

If necessary, the audio channels are provided to an audio delay element, which inserts a delay as needed to synchronize the audio with the appropriate image frame. Each channel then goes through a digital to analog conversion to provide what are known as “line level” outputs to sound system 152. That is, the appropriate analog level or format signals are generated from the digital data to drive the appropriate sound system. The line level audio outputs typically use standard XLR or AES/EBU connectors found in most theater sound systems.

Referring back to FIG. 1, the decoder chassis 144 includes a fiber channel interface 288, the depacketizer 316, the decoder controller or CPU 312, the image decryptor/decompressor 320, the audio decryptor/decompressor 324, and the cryptographic smart card 328. The decoder chassis 144 is a secure, self-contained chassis that also houses the encryption smart card 328 interface, internal power supply and/or regulation, cooling fans (as necessary), local control panel, and external interfaces. The local control panel may use any of various known input devices such as a membrane switch flat panel with embedded LED indicators. The local control panel typically uses or forms part of a hinged access door to allow entry into the chassis interior for service or maintenance. This door has a secure lock to prevent unauthorized entry, theft, or tampering of the system. During installation, the smart card 328 containing the encryption keying information (the auditorium specific key) is installed inside the decoder chassis 144, secured behind the locked front panel. The cryptographic smart card slot is accessible only inside the secured front panel. The RGB signal output from the image decryptor/decompressor 320 to the projector 148 is connected securely within the decoder chassis 144 in such a way that the RGB signals cannot be accessed while the decoder chassis 144 is mounted to the projector housing. Security interlocks may be used to prevent operation of the decoder 144 when it is not correctly installed to the projector 148.

The sound system 152 presents the audio portion of a program on the theater's speakers. Preferably, the sound system 152 receives up to 12 channels of standard format audio signals, either in digital or analog format, from the audio decryptor/decompressor 324.

Alternatively, the playback module 140 and the decoder 144 may be integrated into a single playback-decoder unit 332. Combining the playback module 140 and the decoder module 148 results in cost and access time savings in that only a single CPU (292 or 312) is needed to serve the functions of both the playback module 140 and the decoder 144. Combination of the playback module 140 and the decoder 144 also does not require the use of a fiber channel interface 288.

If multiple viewing locations are desired, information on any storage device 136 is configured to transfer compressed information of a single image program to different auditoriums with preselected programmable offsets or delays in time relative to each other. These preselected programmable offsets are made substantially equal to zero or very small when a single image program is to be presented to selected multiple auditoriums substantially simultaneously. At other times, these offsets can be set anywhere from a few minutes to several hours, depending on the storage configuration and capacity, in order to provide very flexible presentation scheduling. This allows a theater complex to better address market demands for presentation events such as first run films.

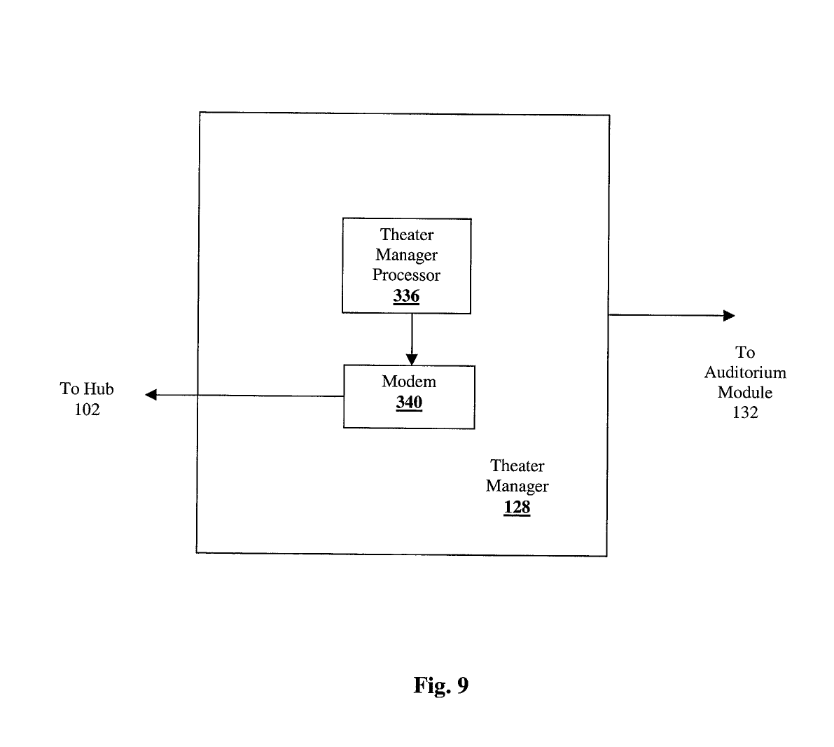

The theater manager 128 is illustrated in greater detail in FIG. 9 of the accompanying drawings. Turning now to FIG. 9, the theater manager 128 provides operational control and monitoring of the entire presentation or theater subsystem 104, or one or more auditorium modules 132 within a theater complex. The theater manager 128 may also use a program control means or mechanism for creating program sets from one or more received individual image and audio programs, which are scheduled for presentation on an auditorium system during an authorized interval.

The theater manager 128 comprises a theater manager processor 336 and may optionally contain at least one modem 340, or other device that interfaces with a return link, for sending messages back to central hub 102. The theater manager 128 may include a visual display element such as a monitor and a user interface device such as a keyboard, which may reside in a theater complex manager's office, ticket booth, or any other suitable location that is convenient for theater operations.

The theater manager processor 336 is generally a standard commercial or business grade computer. The theater manager processor 336 communicates with the network manager 120 and conditional access manager 124 (see FIG. 1). Preferably, the modem 340 is used to communicate with the central hub 102. The modem 340 is generally a standard phone line modem that resides in or is connected to the processor, and connects to a standard two-wire telephone line to communicate back to the central hub 102. Alternatively, communications between the theater manager processor 336 and the central hub 102 may be sent using other low data rate communications methods such as Internet, private or public data networking, wireless, or satellite communication systems. For these alternatives, the modem 340 is configured to provide the appropriate interface structure.

The theater manager 128 allows each auditorium module 132 to communicate with each storage device 136. A theater management module interface may include a buffer memory such that information bursts may be transferred at high data rates from the theater storage device 136 using the theater manager interface 126 and processed at slower rates by other elements of the auditorium module 132.

Information communicated between the theater manager 128 and the network manager 120 and/or the conditional access manager 124 include requests for retransmission of portions of information received by the theater subsystem 104 that exhibiting uncorrectable bit errors, monitor and control information, operations reports and alarms, and cryptographic keying information. Messages communicated may be cryptographically protected to provide eavesdropping type security and/or verification and authentication.

The theater manager 128 may be configured to provide fully automatic operation of the presentation system, including control of the playback/display, security, and network management functions. The theater manager 128 may also provide control of peripheral theater functions such as ticket reservations and sales, concession operations, and environmental control. Alternatively, manual intervention may be used to supplement control of some of the theater operations. The theater manager 128 may also interface with certain existing control automation systems in the theater complex for control or adjustment of these functions. The system to be used will depend on the available technology and the needs of the particular theater, as would be known.

Through either control of theater manager 128 or the network manager 120, the invention generally supports simultaneous playback and display of recorded programming on multiple display projectors. Furthermore, under control of theater manager 128 or the network manager 120, authorization of a program for playback multiple times can often be done even though theater subsystem 104 only needs to receive the programming once. Security management may control the period of time and/or the number of playbacks that are allowed for each program.

Through automated control of the theater manager 128 by the network management module 112, a means is provided for automatically storing, and presenting programs. In addition, there is the ability to control certain preselected network operations from a location remote from the central facility using a control element. For example, a television or film studio could automate and control the distribution of films or other presentations from a central location, such as a studio office, and make almost immediate changes to presentations to account for rapid changes in market demand, or reaction to presentations, or for other reason understood in the art.

The theater subsystem 104 may be connected with the auditorium module 132 using a theater interface network (not shown). The theater interface network comprises a local area network (electric or optical) which provides for local routing of programming at the theater subsystem 104. The programs are stored in each storage device 136 and are routed through the theater interface network to one or more of the auditorium system(s) 132 of the theater subsystem 104. The theater interface network 126 may be implemented using any of a number of standard local area network architectures which exhibit adequate data transfer rates, connectivity, and reliability such as arbitrated loop, switched, or hub-oriented networks.

Each storage device 136, as shown in FIG. 1, provides for local storage of the programming material that it is authorized to playback and display. The storage system may be centralized at each theater system. In this case the theater storage device 136 allows the theater subsystem 104 to create presentation events in one or more auditoriums and may be shared across several auditoriums at one time.

Depending upon capacity, the theater storage device 136 may store several programs at a time. The theater storage device 136 may be connected using a local area network in such a way that any program may be played back and presented on any authorized presentation system (i.e., projector). Also, the same program may be simultaneously played back on two or more presentation systems.

Having thus described the invention by reference to a preferred embodiment it is to be well understood that the embodiment in question is exemplary only and that modifications and variations such as will occur to those possessed of appropriate knowledge and skills may be made without departure from the spirit and scope of the invention as set forth in the appended claims and equivalents thereof.

What we claim as our invention is:

1. An apparatus for conditioning digital image data for display of the image represented thereby, the apparatus comprising:
a store for storing digital image data defining a multiplicity of pixels which together form an image;
a format data table defining a set of parameters for each of a plurality of different image displaying formats; and
an image data processor for reading the digital image data from the store, for formatting the image data depending on the set of parameters for a selected image display format, and for outputting the formatted image data for display of the image represented thereby in the selected image display format.

2. An apparatus as claimed in claim 1, wherein the store is arranged to store digital image data for a plurality of image frames which together form at least a portion of the moving image.

3. An apparatus as claimed in claim 2, wherein the format data table includes a set of parameters corresponding to a progressive scan format, and the store is arranged to output the frames of data to the processor in display order.

4. The apparatus as claimed in claim 3, wherein the image data processor is capable of outputting the formatted image data in a format different than the format in which the digital image data is stored.

5. An apparatus as claimed in claim 2, wherein the format data table includes a set of parameters corresponding to an interleaved scan format and the store is arranged to output the frames of data to the processor in an interleaved field order.

6. An apparatus as claimed in claim 1, wherein the store is arranged to store digital image data defining a static image and the store is arranged to output the frames of data to the processor for continuous display of the static image over a period of time.

7. An apparatus as claimed in claim 1, wherein the format data table is generated by software, thereby enabling the parameters to be added to, changed and updated as necessary.

8. An apparatus as claimed in claim 1, wherein the image data processor comprises a video formatting state machine.

9. An apparatus as claimed in claim 8, wherein the state machine includes a state in which control signals corresponding to blanking intervals are generated.

10. An apparatus as claimed in claim 9, wherein the blanking intervals correspond to horizontal blanking intervals.

11. An apparatus as claimed in claim 9, wherein the blanking intervals correspond to vertical blanking intervals.

12. An apparatus as claimed in claim 8, wherein the state machine includes a state in which blanking pixels are generated.

13. An apparatus as claimed in claim 1, further comprising a buffer between the store and the state machine.

14. An apparatus as claimed in claim 13, wherein the buffer comprises a first-in-first-out register.

15. An apparatus as claimed in claim 1, further comprising a projector for displaying the image represented by the formatted image data.

16. A method of conditioning digital image data for display of the image represented thereby, the method comprising:
storing digital image data defining a multiplicity of pixels which together form an image;
defining a set of parameters for each of a plurality of different image displaying formats;
formatting the image data depending on the set of parameters for a selected image display format; and
outputting the formatted image data for display of the image represented thereby in the selected image display format.

17. A method as claimed in claim 16, further comprising storing digital image data for a plurality of image frames which together form at least a portion of the moving image.

18. A method as claimed in claim 17, wherein the set of parameters includes a set of parameters corresponding to a progressive scan format, and the method further comprises supplying the frames of data for formatting in display order.

19. A method as claimed in claim 18, wherein outputting the formatted image data for display is in a format different than the format in which the digital image data is displayed.

20. A method as claimed in claim 17, wherein the set of parameters includes a set of parameters corresponding to an interleaved scan format and the method further comprises supplying data for each frame for formatting in an interleaved field order.

21. A method as claimed in claim 16, further comprising storing digital image data defining a static image; and supplying repeatedly the image data for formatting for continuous display of the static image over a period of time.

22. A method as claimed in claim 16, wherein the set of parameters is generated by software, thereby enabling the parameters to be added to, changed and updated as necessary.

23. A method as claimed in claim 16, further comprising displaying the image represented by the formatted image data.

24. An image data processing system comprising:
an input device for receiving image data defining a multiplicity of pixels that together form an image;
a programmable format data store for storing format data defining a format in which the image data is to be output for display of the image; and
a processor for receiving the image data from the input device and processing the same depending on the format data in the programmable format data store to generate image data including control data corresponding to the format defined by the format data in the format data store.

25. An image data processing system as claimed in claim 24, wherein the input device comprises a buffer.

26. An image data processing system as claimed in claim 25, wherein the buffer comprises a first-in-first-out register.

27. An image data processing system as claimed in claim 25, wherein the input device is adapted to receive the image data in a decimated format.

28. An image data processing system as claimed in claim 27, wherein the input device comprises separate parallel sections for receiving respective components of the decimated image data.

29. An image data processing system as claimed in claim 24, wherein the processor comprises a video formatting state machine.

30. An apparatus as claimed in claim 29, wherein the state machine includes a state in which control signals corresponding to blanking intervals are generated.

31. An apparatus as claimed in claim 30, wherein the blanking intervals correspond to horizontal blanking intervals.

32. An apparatus as claimed in claim 30, wherein the blanking intervals correspond to vertical blanking intervals.

33. An apparatus as claimed in claim 29, wherein the state machine includes a state in which blanking pixels are generated.

34. A method of image data processing comprising:
receiving image data defining a multiplicity of pixels that together form an image;
generating format data defining a format in which the image data is to be output for display of the image; and
processing the image data from the input device depending on the format data in the programmable format data store to generate image data including control data corresponding to the format defined by the format data in the format data store.

35. A method as claimed in claim 34, further comprising receiving the image data in a decimated format.

36. A method as claimed in claim 35, further comprising receiving respective components of the decimated image data in parallel.

37. A method as claimed in claim 34, further comprising generating control signals corresponding to blanking intervals.

38. A method as claimed in claim 37, wherein the blanking intervals correspond to horizontal blanking intervals.

39. A method as claimed in claim 37, wherein the blanking intervals correspond to vertical blanking intervals.

40. A method as claimed in claim 34, further comprising generating blanking pixels.

41. A digital cinema system in which image data acquired in a first format is processed to remove control data therefrom and leave stripped data defining a multiplicity of pixels that together represent an image, the stripped data is delivered to a display sub-system together with data identifying the first format, at which display sub-system the stripped data is processed by a video processor which adds to the stripped data further data to convert the stripped data into reformatted data representing the image in a second format which is output to a display device for display of the image represented thereby.

42. A digital cinema system as claimed in claim 41, wherein the second format is different than the first format.

43. A digital cinema system as claimed in claim 41, wherein the stripped data is delivered to a display sub-system in scrambled form, the display sub-system comprising a descrambling circuit for descrambling the stripped data.

44. A digital cinema system as claimed in claim 41, wherein the further data comprises data defining display blanking intervals.

45. A digital cinema system as claimed in claim 44, wherein the display blanking intervals comprise horizontal blanking intervals.

46. A digital cinema system as claimed in claim 44, wherein the display blanking intervals comprise vertical blanking intervals.

47. A digital cinema system as claimed in claim 41, wherein the further data comprises data defining special codes.

48. A digital cinema system as claimed in claim 41, wherein the further data comprises data defining blanking pixels.

49. A video display system in which data defining an image is supplied as pixel data and is formatted before being output for display, the system comprising:
means for storing the pixel data;
means for reading the pixel data, from the means for storing, in display order;
means for selecting a display format in which the image is to be displayed;
processing means, coupled to the means for reading and to the means for defining, for processing the pixel data to create display data by adding control data corresponding to the format selected for display.

50. A video display system as claimed in claim 49, further comprising:
means, coupled to the processing means and responsive to the control data in the display data, for displaying the image represented by the display data.

51. A video display system as claimed in claim 49, wherein the means for selecting a display format comprises means for defining the control data to be added to the pixel data by the processing means.

52. A video display system as claimed in claim 49, wherein the means for selecting a display format is programmable.

53. A video display method in which data defining an image is supplied as pixel data and is formatted before being output for display, the system comprising:
storing the pixel data;
reading the stored pixel data in display order;
selecting a display format in which the image is to be displayed;
processing the pixel data to create display data by adding control data corresponding to the format selected for display.

54. A video display method as claimed in claim 53, further comprising displaying the image represented by the display data.

55. A video display method as claimed in claim 53, wherein the step of selecting a display format comprises defining the control data to be added to the pixel data in the processing step.
